(19) United States
(12) Patent Application Publication
(10) Pub. No.: US 2025/0068135 A1
(43) Pub. Date: Feb. 27, 2025

(54) Raw Sensor Data Input to Control System

(71) Applicant: Fisher-Rosemount Systems, Inc., Round Rock, TX (US)

(72) Inventors: Mark Nixon, Round Rock, TX (US); Gary K. Law, Round Rock, TX (US)

(21) Appl. No.: 18/453,791

(22) Filed: Aug. 22, 2023

(51) Int. Cl. G05B 15/02

(52) U.S. Cl. CPC G05B 15/02

(57) ABSTRACT

Systems, methods, and media for monitoring and controlling an operation (e.g., an automotive manufacturing operation, a chemical processing operation, an oil and gas operation, etc.) using raw sensor data inputs. A system includes a sensor device and a control system in electrical communication with the sensor device. The sensor device includes a sensor configured to generate an electrical signal indicative of a measured process variable and a converter circuit configured to receive the electrical signal and generate a raw sensor data packet using the electrical signal. The control system is configured to receive the raw sensor data packet from the sensor device, calculate a value for the measured process variable based on the raw sensor data packet, and control the operation based on the value for the measured process variable.

### BACKGROUND

Control systems for various types of complex processes (e.g., automotive manufacturing, chemical processing, oil and gas, food and beverage, medical manufacturing, water treatment, paper manufacturing, mining, metal processing, packaging, filling, etc.) rely on various electrical devices and systems for proper process monitoring and control.

### SUMMARY

One aspect of the present disclosure is a system for monitoring and controlling an operation. The system includes a sensor device and a control system in electrical communication with the sensor device. The sensor device includes a sensor configured to generate an electrical signal indicative of a measured process variable associated with the operation and a converter circuit configured to receive the electrical signal from the sensor and generate a raw sensor data packet using the electrical signal. The control system includes one or more circuits configured to receive the raw sensor data packet from the sensor device; calculate a value for the measured process variable based on the raw sensor data packet; and control the operation based on the value for the measured process variable.

Another aspect of the present disclosure is one or more non-transitory computer-readable storage media having instructions stored thereon that, when executed by one or more processors, cause the one or more processors to implement operations. The operations include receiving a raw sensor data packet from a sensor device, the raw sensor data packet comprising a raw value indicative of a measured process variable associated with an operation and a sensor identifier associated with the sensor device; identifying a translation function associated with the sensor device that is maintained by a control system for the operation using the sensor identifier associated with the sensor device; applying the raw value indicative of the measured process variable associated with the operation to the translation function to generate a translated value; determining a value for the measured process variable associated with the operation based on the translated value; and controlling the operation based on the value for the measured process variable.

Yet another aspect of the present disclosure is a method for monitoring and controlling an operation. The method includes receiving, by a control system, a raw sensor data packet from a sensor device, the raw sensor data packet comprising a raw value indicative of a measured process variable associated with an operation and a sensor identifier associated with the sensor device; identifying, by the control system, a model associated with the sensor device that is maintained by a control system for the operation using the sensor identifier associated with the sensor device; applying, by the control system, the raw value indicative of the measured process variable associated with the operation to the model; determining, by the control system, a value for the measured process variable associated with the operation based on an output of the model; and controlling, by the control system, the operation based on the value for the measured process variable.

### BRIEF DESCRIPTION OF THE DRAWINGS

FIG. 1 is a block diagram illustrating an example system for monitoring and controlling an operation, in accordance with some aspects of the disclosure.

FIG. 2 is a block diagram showing an example raw sensor data packet that can be used by the system of FIG. 1, in accordance with some aspects of the disclosure.

FIG. 3 is a block diagram showing additional example components of the system of FIG. 1, in accordance with some aspects of the disclosure.

FIG. 4 is a block diagram showing additional example components of the system of FIG. 1, in accordance with some aspects of the disclosure.

FIG. 5 is an illustration of an example fluid tank that can be monitored and controlled by the system of FIG. 1 is shown, in accordance with some aspects of the disclosure.

FIG. 6 is a flowchart illustrating an example process for generating and transmitting a raw sensor data input in the system of FIG. 1, in accordance with some aspects of the disclosure

FIG. 7 is a flowchart illustrating an example process for controlling an operation using a raw sensor data input in the system of FIG. 1, in accordance with some aspects of the disclosure.

### DETAILED DESCRIPTION

Control systems for various types of complex processes (e.g., automotive manufacturing, chemical processing, oil and gas, food and beverage, medical manufacturing, water treatment, paper manufacturing, mining, metal processing, packaging, filling, etc.) rely on various electrical devices and systems for proper process monitoring and control. Given the highly sensitive nature of many processes, the ability to provide more dynamic monitoring and control functionality can provide significant value.

In some systems for monitoring and controlling various types of operations, sensor devices used to measure different process variables (e.g., temperature, pressure, flow, level, concentration, etc.) include significant electronic components for processing sensor inputs. For example, the sensor device typically includes a sensing element (e.g., a thermocouple, etc.) that produces an electrical output indicative of a measure process variable. Then, the sensor device also includes electronics to manipulate the electrical output produced by the sensing element in a significant way. For example, the electronics on the sensor device itself can perform signal manipulation such as, for example, amplification, linearization, converting and scaling (e.g., to predefined engineering units), sensor element excitation, and compensating for errors caused by operational conditions such as, for example, extreme temperature levels. However, these approaches can have a variety of drawbacks, such as, for example, security vulnerabilities, difficulty of configuration, inefficient replacement, inaccurate calculations, difficulty of implementing updates, limited computing resources, and other potential drawbacks.

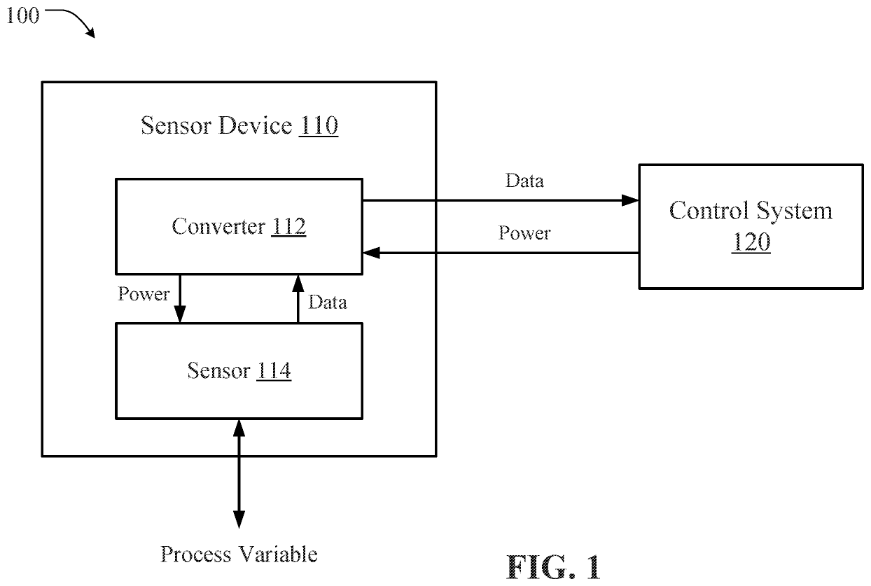

Referring to FIG. 1, a block diagram illustrating an example system 100 for monitoring and controlling an operation is shown, in accordance with some aspects of the disclosure. The system 100 can be implemented in a variety of different applications. For example, the system 100 can be implemented to monitor and control a variety of different manufacturing and material processing operations, such as, for example, an automotive manufacturing operation, a chemical processing operation, an oil and gas operation, a food and beverage manufacturing operation, a medical manufacturing operation, a paper manufacturing operation, a water treatment operation, a mining operation, a packaging and filling operation, and other types of operations. The system 100 is shown to include a sensor device 110 in electrical communication with a control system 120. The sensor device 110 is shown to include a converter 112 and a sensor 114. The system 100 can generally be used to reduce the electronics that need to be included on the sensor device 110 when compared to approaches that include sensor devices with additional hardware and/or software to manipulate signals before transmission, such as discussed above. Also, the system 100 can be used to provide more dynamic and broad-based control functionality for an operation by incorporating sensor data processing steps in the control system 120 as opposed to the sensor device 110.

The sensor device 110 can generally be described as a “smart sensor” that measures one or more process variables associated with an operation. The sensor device 110 can be defined by a physical housing (enclosure). The housing can be implemented in a variety of ways depending on the intended application. For example, the housing can be formed using various suitable types of plastics, metals, and other suitable materials and combinations thereof. The sensor device 110 can be one of several similar sensor devices setup within the system 100 to monitor different process variables for an operation that are all in electrical communication with the control system 120. As will be detailed further below, the data from these sensor devices can be leveraged together by the control system 120 to generate more accurate values for process variables associated with the operation and to provide more dynamic control functionality.

In addition to the converter 112 and the sensor 114, the sensor device 110 can include other components such as, for example, a communications interface (e.g., a two-wire digital communication interface or an Ethernet-APL interface), processing circuitry, and memory, for example. As shown in FIG. 1, the sensor device 110 can receive power (e.g., 12, 24, or 48 volts DC power) from the control system 120 and send data to the control system 120. The sensor device 110 generally includes minimal processing electronics when compared to other approaches, such as discussed above, which can allow the sensor device 110 to be designed and manufactured at lower cost.

The control system 120 and the sensor device 110 may be physically separate devices rather than part of an integrated unit. For example, the sensor device 110 may have a separate housing from a housing (or housings) of the control system 120. Additionally, the control system 120 (or a portion thereof) and the sensor device 110 may be within a same industrial facility, but may be several meters, tens of meters, or hundreds of meters apart from one another. In some examples, the data and power provided between the control device 120 and the sensor device 110 may be provided over a two-wire interface including a twisted pair of wires over which both power and data are provided (e.g., according to the Ethernet-APL protocol or another protocol).

The converter 112 can be implemented in a variety of ways, including as an analog-to-digital (ADC) converter circuit. The converter 112 can be configured using a variety of different parameters, such as, for example, different sampling rates and bit resolution. Also, the converter 112 can be implemented using any suitable type of converter circuit, such as, for example, a delta-sigma (AZ) analog-to-digital converter, a successive approximation analog-to-digital converter, a dual slope analog-to-digital converter, and other suitable types of converter circuits.

As shown in FIG. 1, the sensor 114 can provide data including the electrical signal to the converter 112 and receive power (e.g., an excitation voltage) from the converter 112. The output of the converter 112 can be the raw value 210 of the raw sensor data packet 200 discussed below, for example. In some examples, the converter 112 can generate the full raw sensor data packet 200 (e.g., including the raw value 210, the sensor identifier 220, and the sensor operational data 230). In other examples, another circuit included in the sensor device 110 (e.g., a processing circuit) can generate parts of the raw sensor data packet 200 (e.g., the sensor identifier 220 and/or the sensor operational data 230).

The sensor 114 can be implemented using any suitable sensing elements, transducers, etc. that can measure a process variable. For example, the sensor 114 can be implemented using a thermocouple, a thermistor, a force-sensing resistor, a strain gauge, a piezoelectric element (e.g., a piezoelectric disc, plate, or transducer), a differential transformer, a capacitive pressure transducer, or any other suitable type of sensor and/or combination of sensors. The sensor 114 can measure any suitable type of process variable, such as, for example, a temperature process variable, a pressure process variable, a flow process variable, a level process variable, a concentration process variable, and/or any other suitable type of process variable. The sensor 114 can be positioned within the housing of the sensor device 110 in a variety of manners depending on the intended application. The sensor 114 can generally be configured to generate an electrical signal indicative of the measured process variable. The electrical signal can be an analog voltage signal or an analog current signal, for example.

The control system 120 can be implemented in a variety of ways. For example, the control system 120 can be implemented using one or more remote (e.g., cloud-based) servers. The control system 120 can also be implemented using one or more on-premises servers (e.g., servers on-site at a manufacturing facility), or using a hybrid approach including one or more remote servers in combination with one or more on-premises servers. Additionally, the control system 120 can include and/or be in communication with one or more higher level control and/or networking devices that are used to monitor and control a given operation. The control system 120 can include various types of controllers that affect the operation based on the data generated by the sensor device 110 (e.g., by executing control algorithms). The control system 120 can also include network switches and/or gateway devices that facilitate electrical communication between devices associated with the operation. For example, the sensor device 110 can be in electrical communication with a networking device (e.g., the network device 320 described below) such as, for example, a switch via an Ethernet-APL connection, and then the switch can send the raw sensor data packet 200 to a server via a wireless communication protocol (e.g., the Internet, a cellular connection, a plant network, etc.).

The control system 120 generally has far greater processing resources (e.g., available memory and computing power) when compared to the resource constraints that may be present on an individual sensor device. As a result, the control system 120 can perform more dynamic analysis of the raw sensor readings (e.g., the electrical signal produced by the sensor 114) than electronics on the sensor device 110 itself would be able to. For example, as detailed further below, the control system 120 can generate a virtual sensor that combines readings from multiple sensor devices to determine a separate process variable. Moreover, the control system 120 can dynamically apply different types of translation functions, corrective functions, and models to determine more accurate values for different process variables than otherwise possible using the constrained resources and lack of data available on an individual sensor device.

Although FIG. 1 illustrates the control device 120 interfacing with a single sensor device 110, in some examples, the control device 120 is coupled to a plurality of sensor devices similar to the sensor device 110. In some examples, each such sensor device may operate similar to the sensor device 110 described herein (sensing similar or different process variables), and the control device 120 may interface with each such sensor device in a similar way as described with respect to the sensor device 110. In other words, the control device 120 may receive raw sensor data from a plurality of such sensor devices, manipulate such raw sensor data, and monitor and/or control an operation (via control of controllable devices) based on such manipulated raw sensor data.

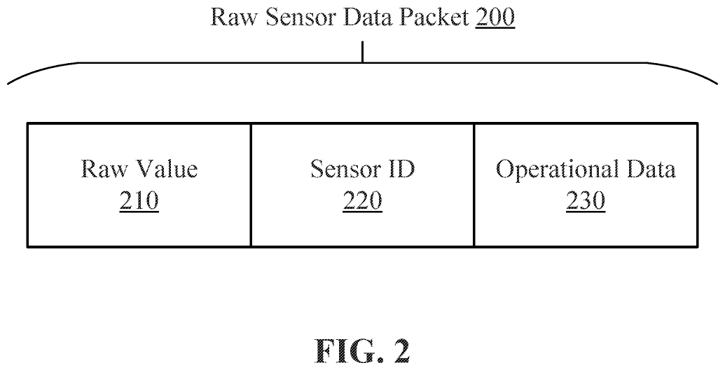

Referring to FIG. 2, a block diagram showing an example raw sensor data packet 200 that can be used by the system 100 is shown, in accordance with some aspects of the disclosure. The raw sensor data packet 200 can be generated by the sensor device 110 and transmitted to the control system 120 using any suitable communications protocol. In some examples, the sensor device 110 is configured to send the raw sensor data packet 200 to the control system 120 using Ethernet with an Advanced Physical Layer (Ethernet-APL) communications. The raw sensor data packet 200 is shown to include a raw value 210, a sensor identifier (ID) 220, and sensor operational data 230. The raw sensor data packet 200 can be a digital data packet with any suitable resolution of bits. The raw value 210, the sensor identifier 220, and the sensor operational data 230 can be identified by the control system 120 using specific bits in the raw sensor data packet 200, for example.

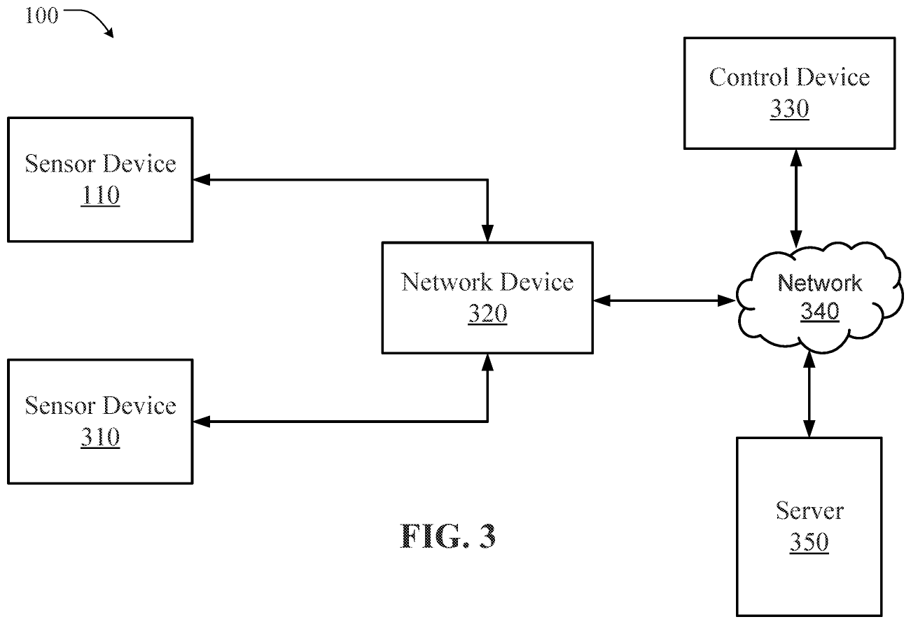

The use of Ethernet-APL specifically in the system 100 to transfer the raw sensor data packet 200 from the sensor device 110 to the control system 120 (e.g., to a networking device in the control system 120) can provide a variety of advantages. For example, improvements in terms of enabling long cable lengths and safety protections can be achieved using Ethernet-APL. The raw sensor data packet 200 can advantageously be generated by the sensor device 110 using minimal processing electronics, which can help reduce the cost of manufacturing the sensor device 110, among other advantages. As noted above, the sensor device 110 can send the raw sensor data packet 200 to a networking device of the control system 120 using Ethernet-APL (e.g., the network device 320 of FIG. 3), and then the networking device can send the raw sensor data packet 200 to a server (e.g., a cloud-based server or an on-premises server, such as, for example, the server 350 of FIG. 3).

The raw value 210 can generally be the output of the converter 112. For example, the raw value 210 can be a full resolution (e.g., 0-100%) digital version of the electrical signal generated by the sensor 114 to measure the process variable. It is important to note that the raw value 210 is in fact “raw” in that it typically needs further processing (e.g., amplification, linearization, converting and scaling) before it can be used as a control input. However, in the system 100, these further processing steps notably are not performed on the sensor device 110, but rather by the control system 120. Accordingly, the raw value 210 is not manipulated by the sensor device 110 beyond the conversion (e.g., analog-to-digital conversion) performed by the converter 112. That is, at least in some examples, the sensor device 110 does not perform any manipulation of the signal output by the converter 112, such as, for example, by performing amplification, linearization, converting and scaling, or other types of signal manipulation functions.

The sensor identifier 220 can be associated with the sensor device 110 and used to identify the sensor device 110. For example, the sensor identifier 220 can be a unique identifier of the sensor device 110 that is specific to a particular sensor (e.g., associated with unique compensation or calibration information determined during manufacture or install), a particular type of sensor, and/or a particular family of sensor (e.g., manufacturer X and type Y). The sensor identifier 220 can be used by the control system 120 to determine a variety of information associated with the sensor device 110, such as, for example, via the sensor library 122 discussed below. The control system 120 can use the sensor identifier 220 to identify one or more translation functions, one or more corrective functions, and/or one or more models associated with the sensor device 110, for example, as detailed further below. The inclusion of the sensor identifier 220 in the raw sensor data packet 200 can also provide advantages in terms of ease of configurability and efficient sensor replacement.

The sensor operational data 230 can include data that is indicative of an operational state of the sensor device 110 at a time when the converter 110 generates the raw sensor data packet 200. For example, in temperature-sensitive applications, the sensor operational data 230 can include temperature data indicative of an operational temperature associated with the sensor device 110 at the at the time when the sensor device 110 generated the raw sensor data packet 200. In pressure-sensitive application, the sensor operational data 230 can include pressure data indicative of an operational pressure associated with the sensor device 110 at the at the time when the sensor device 110 generated the raw sensor data packet 200. The control system 120 can use the sensor operational data 230 to compensate for the operational state of the sensor device 110 at the time when the sensor device 110 generated the raw sensor data packet 200. For example, as detailed further below, the control system 120 can apply a corrective function to compensate for process temperature variations and thereby improve the calculation accuracy of the measured process variable.

Referring to FIG. 3, a block diagram showing additional example components of the system 100 is shown, in accordance with some aspects of the disclosure. Specifically, the block diagram shown in FIG. 3 includes the sensor device 110 as well as a sensor device 310, a network device 320, a control device 330, a network 340, and a server 350. The sensor device 310 can be a second sensor device that is similar to the sensor device 110, but measures a second process variable associated with the operation that is different from the first process variable measured by the sensor device 110. The network device 320, the control device 330, and the server 350 can all be components of the control system 120, for example. The network device 320 can be a gateway device, a network switch, a router, or another similar type of networking device used to route electronic communications within the system 100. The sensor device 110 can send the raw sensor data packet 200 (e.g., a first raw sensor data packet) to the network device 320. Similarly, the sensor device 310 can send a second raw sensor data packet similar to the raw sensor data packet 200 to the network device 320. It is important to note that the configuration shown in FIG. 3 is provided as an example, and is not intended to be limiting. For example, in some configurations, additional sensor devices (similar to sensor device 110 and/or 310) are provided and in communication with the network device 320 (and interact with the system 100) in a similar manner as described with respect to the sensor device 110 and/or 310.

Via the network 340, the network device 320 can then send the raw sensor data packets from the sensor device 110 and the sensor device 310 to the server 350. The network 340 can be any suitable type of electronic communications network, such as, for example, a Wi-Fi network, the Internet, a cellular network, and/or other similar types of networks. The server 350 can be an on-premises server or a remote cloud-based server, for example. Although illustrated as a single block in FIG. 3, in some examples, the server 350 may comprise a plurality of servers (co-located with one another, distributed in multiple locations, or a combination thereof). As detailed further below, the server 350 can use and manipulate the raw data packets from the sensor device 110 and the sensor device 310 in a variety of ways to provide more dynamic monitoring and control functionality for the operation. The operation can be controlled based on values for different process variables that are determined by the server 350 using the raw data packets from the sensor device 110 and the sensor device 310. For example, the server 350 can send one or more control signals to the control device 330 such that the control device 330 uses the one or more control signals to affect the operation (e.g., by controlling machinery, controlling fluid flow, operating different devices and systems, etc.). For example, the control device 330 may be or include one or more of a motor, a pump, a valve, a solenoid, or other controllable device or actuator. Also, in some examples, the server 350 can send data (e.g., values for different process variables that are determined by the server 350 using the raw data packets from the sensor device 110 and/or the sensor device 310) to the control device 330 such that the control device 330 uses the data (e.g., by applying it as input to one or more control algorithms) to determine one or more control decisions for affecting the operation. Control device 330 can be implemented as any suitable controller that sends control signals to affect the operation monitored and controlled by the system 100.

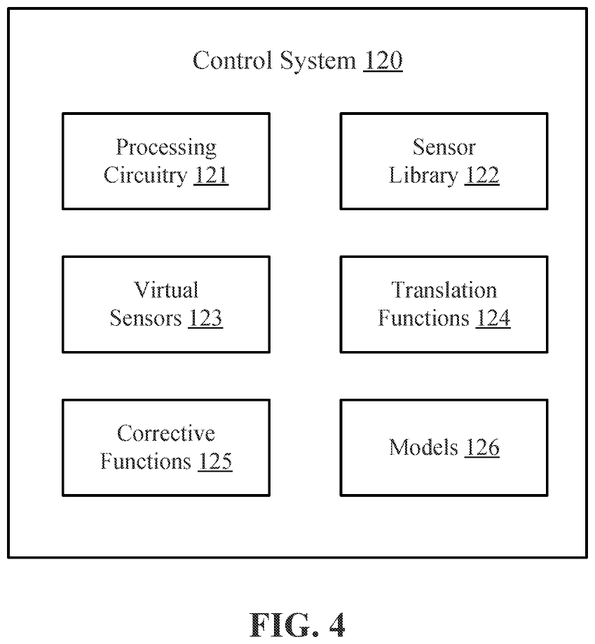

Referring to FIG. 4, a block diagram showing example components of the control system 120 is shown, in accordance with some aspects of the disclosure. As noted, the control system 120 can be implemented in a variety of ways, including using one or more remote (e.g., cloud-based) servers, one or more on-premises servers (e.g., servers on-site at a manufacturing facility), or using a hybrid approach including one or more remote servers in combination with one or more on-premises servers. The control system 120 can also include additional devices such as, for example, the network device 320 and the control device 330 shown in FIG. 3. Each of the components of the control system 120 can be maintained by one or more remote (e.g., cloud-based) servers, in some examples, to provide dynamic monitoring and control functionality.

The processing circuitry 121 can be implemented using any suitable different types and combinations of hardware processing components or processors. For example, the processing circuity 121 can include one or more central processing units (CPUs), graphics processing units (GPUs), and/or other types and combinations of hardware processing components. Additionally, the processing circuity 121 can be distributed across multiple separate devices, such as, for example, distributed across multiple servers in a datacenter and/or distributed across different control devices in the control system 120 (e.g., the control device 330 and/or the network device 320). The processing circuitry 121 can generally be configured to, among other functions, process data (e.g., the raw sensor data packet 200) from smart sensor devices (e.g., the sensor device 110 and the sensor device 310) to monitor and control a given operation. The processing circuitry 121 can execute machine-readable instructions stored in various types of memory, such as, for example, any suitable volatile memory, non-volatile memory, storage, or any suitable combination thereof. For example, the memory can include random-access memory (RAM), read-only memory (ROM), electrically erasable programmable read-only memory (EEPROM), one or more flash drives, one or more hard disks, one or more solid state drives, one or more optical drives, and the like. The processing circuitry 121 can, for example, execute instructions stored on one or more non-transitory computer-readable storage media to implement process monitoring and control operations.

The sensor library 122 can include a variety of information associated with different types of sensors used in the system 100. For example, the sensor library 122 can be queried using the sensor identifier 220 to identify one or more translation functions 124, one or more corrective functions 125, and/or one or more models 126 associated with the sensor device 110. The sensor library 122 can be structured in a variety of suitable manners. For example, the sensor library 122 may include a datastore or table of sensor identifiers mapped to respective translation functions of the translation functions 124, corrective functions of the corrective functions 125, and/or models of the models 126. Accordingly, in some examples, in response to inputting a sensor identifier (e.g., the sensor identifier 220) to the sensor library 122, a particular translation function (or functions) of the translation functions 124, a particular corrective function (or functions) of the corrective functions 125, and/or a particular model (or models) of the models 126 associated with the identified sensor is obtained for use by the control system 120. Among other benefits, the use of the sensor library 122 can provide advantages in terms of updatability of the system 100. For example, consider a situation where an improved signal processing algorithm is developed for complex smart sensors such as, for example, guided wave radar level sensors. In such a scenario, the improved signal processing algorithm can be associated with the appropriate sensor identifier(s) in the sensor library 122 instead of pushing a firmware update to the guided wave radar level sensors.

The virtual sensors 123 can include any data used by the control system 120 to monitor and control a given operation that is not necessarily associated with a particular physical sensor device (e.g., the sensor device 110). For example, the control system 120 can combine data from multiple smart sensor devices (e.g., the sensor device 110 and the sensor device 310) in various ways to provide added information that may not be evident when looking at data from any one single smart sensor device. Consider an operation with (i) a centrifugal pump having a smart vibration sensor and a smart run status, (ii) an upstream tank with a smart level sensor, and (iii) a downstream smart pressure sensor. In such an operation, the control system 120 can create a virtual cavitation sensor that provides an automated indication of a cavitation condition based on the combined data from the sensors associated with (i), (ii), and (iii). In this case, the virtual cavitation sensor is not a physical sensor installed in the field, but rather is a virtual sensor made possible by the fact that the control system 120 has access to the data from the sensors associated with (i), (ii), and (iii). As another example, consider a fluid tank (e.g., the fluid tank 500 described below) with at least two separate smart pressure sensors configured to measure different pressures associated with the tank. In this example, the control system 120 can create a virtual level sensor that provides an automatic indication of the fluid level in the tank based on the combined readings from the smart pressured sensors.

The virtual sensors 125, and the control system 120 more broadly, can be used to infer measurements from other measurements around a particular measurement. As a result, the control system 120 can be used to validate certain measured process variables, such as validating that a tank (e.g., the fluid tank 500, etc.) is actually filling. The validation of measurements can be useful for identifying failed measurements, identifying measurements that are drifting, identifying sensors that need to be re-calibrated (e.g., because a measured tank level is not accurate, etc.), and other potential advantages. Moreover, the virtual sensors 125, and the control system 120 more broadly, can also be used to combine measurements with mass and/or energy balances to identify process issues present in a given operation. For example, the control system 120 can be configured to combine measurements with mass and/or energy balances to identify leaks in pipes, leaks in tubing in furnaces, leaks in tanks, localized flooding in columns, localized reactions in a reactor, and other process issues. The virtual sensors 125 can be used by the control system 120 to generate, monitor, and use predictive measurements, for example by integrating mass and/or energy balances to validate process operation. Using the enhanced computing capabilities provided by the control system 120 (e.g., through the server 350), enhanced calculations that leverage the virtual sensors 125 can be performed by the control system 120 to show a “safe region” (e.g., via a graphical user interface, etc.) that a given process should be operating in.

The translation functions 124 can include any suitable functions for calculating values for different measured process variables associated with an operation based on raw data values received from smart sensor devices. For example, consider a case where the sensor device 110 sends the raw sensor data packet 200, including the raw value 210, to the control system 120. Also, consider that the raw value 210 is a full resolution (e.g., 0-100%) digital value indicating a measured temperature associated with a given operation. Using the sensor identifier 220 (e.g., as described above with respect to the sensor library 122), the control system 120 can identify an appropriate one of the translation functions 124 that converts the raw value 210 to a temperature value in a specified engineering range (e.g., 300° F.-600° F., 0° C.-200° C., etc.). Then, the control system 120 can apply the raw value 210 to the identified translation function to generate a translated value. The use of the translation functions 124 can provide advantages in terms of ease of configurability and updateability. For example, instead of requiring a firmware update to the sensor device 110 to use a new and improved type of translation function, the transition function can be updated in the control system 120 (e.g., in the cloud) and associated with one or more particular sensor identifiers. The translation functions 124 can take various forms, such as, for example, various types of relationship curves, scaling functions, linearization functions, amplification functions, and other types of functions that can be used to translate the raw value 210 into an accurate, meaningful value for a measured process variable associated with a given operation. The translation functions 124 can be fine-tuned (e.g., trained) over time to provide more and more accurate monitoring and control functionality.

The corrective functions 125 can include any suitable functions used to compensate for the operational state of the sensor device 110 at the time when the sensor device 110 generates the raw sensor data packet 200. The surrounding temperature, pressure, concentration, fluid level, pH, etc. at the time when the sensor device 110 generates the raw sensor data packet 200 may affect the raw value 210 received by the control system 120. For example, in extreme temperature environments, the electrical signal generated by the sensor 114 may include some level of error or shift. In such scenarios, the control system 120 uses the operational state of the sensor device 110 at the time when the sensor device 110 generates the raw sensor data packet 200 to generate an accurate value for the given measured process variable.

The control system 120 can use the sensor identifier 220 (e.g., as described above with respect to the sensor library 122) to identify an appropriate one of the corrective functions 125 for the raw sensor data packet 200. Then, the control system 120 can apply the sensor operational data 230 to the identified corrective function to generate a corrective value. The control system 120 can then generate a final, usable value for the measured process variable by combining the translated value and the corrective value, in some examples. The corrective functions 125 can take various forms, such as, for example, various types of relationship curves, scaling functions, linearization functions, amplification functions, and other types of functions that can be used to account for the operational state of the sensor device 110 at the time when the sensor device 110 generates the raw sensor data packet 200. The corrective functions 125 can be fine-tuned (e.g., trained) over time to provide more and more accurate monitoring and control functionality.

The models 126 can include any suitable types of models for calculating values for different process variables associated with a given operation. For example, the models 126 can include various types of machine learning and artificial intelligence models, including supervised models (e.g., support-vector machines, decision trees, linear/logistic regression models, neural networks, etc.), unsupervised models (e.g., clustering algorithms, anomaly detection algorithms, etc.), deep learning models, semi-supervised models, and the like. In some examples, the control system 120 can identify one of the models 126 that is associated with the sensor device 110 based on the sensor identifier 220 (e.g., as described above with respect to the sensor library 122). Then, the control system 120 can apply the raw value 210 as input to the identified model and determine a value for a measured process variable based on an output of the model.

Further, the control system 120 can apply the sensor operational data 230 as input to the model such that the output of the model accounts for the operational state of the sensor device 110 at the time when the sensor device 110 generates the raw sensor data packet 200. Moreover, the models 126 can be used to account for multiple sensors associated with the system 100 for more dynamic monitoring and control functionality. For example, the control system 120 can apply raw values received from both the sensor device 110 and the sensor device 310 as input to a given model. The control system 120 can also apply values associated with the virtual sensors 123 as input to the models 126. Accordingly, the models 126 can be used to provide more accurate sensor data calculations by accounting for multiple sensor values associated a given operation. The models 126 can be fine-tuned (e.g., trained) over time to provide more and more accurate monitoring and control functionality.

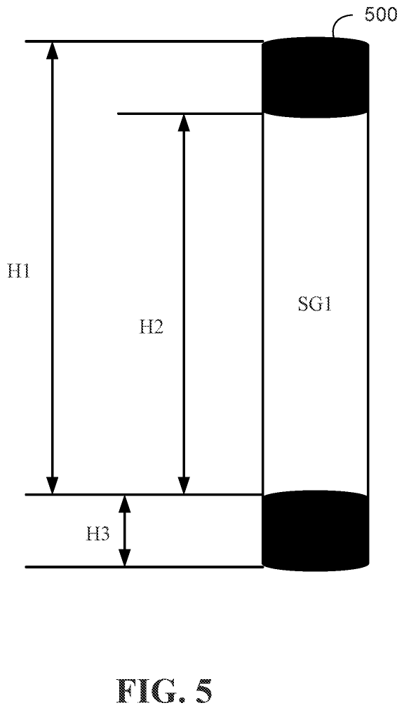

Referring to FIG. 5, an illustration of an example fluid tank 500 that can be monitored and controlled by the system 100 is shown, in accordance with some aspects of the disclosure. One or more of the models 126 can be used to automate various calculations using smart sensor data received from devices such as the sensor device 110 and the sensor device 310, for example. A model can be designed and maintained by the control system 120 that represents a process associated with the tank based on the physical tank properties and the properties of the fluid maintained and controlled by the fluid tank 500. The model can be designed by engineers, or can be designed at least in part automatically by the control system 120 itself (e.g., using pre-built algorithms, generative artificial intelligence, etc.).

The illustration in FIG. 5 shows different physical properties of the fluid tank 500, including a height H₁, a height H₂, a height H₃, and specific gravity of the fluid SG₁. These variables can be used and/or calculated by the model designed for the fluid tank 500. One or more smart sensor devices, such as, for example, the sensor device 110 and/or the sensor device 310, can be installed at advantageous positions on the fluid tank 500 to measure different variables associated with the fluid tank 500. For example, one or more smart sensor devices could be installed to measure the differential pressure between the upper and lower tarps, and then the model could be used to calculate the height of the liquid level automatically based on the differential pressure. Various known properties associated with the fluid tank could be used to design the model, such as, for example, the variables shown, the vertical location of the tank taps, properties associated with the capillary fill fluid, and other possible known properties.

In some previous approaches that do not use a model and the one or more smart sensor devices, such as, for example, the sensor device 110 and/or the sensor device 310, complex configuration may be required for proper operation. For example, the transmitter in some previous approaches may be individually configured (e.g., to specify certain parameters), and the configuration in such cases typically needs to be matched by the control system. As a result, there may be a significant potential for a mismatch in configuration. For example, if the transmitter is ranged at 0-20 pounds per square inch gauge (psig), the corresponding engineering unit values in the control system need to be configured to match that range or the displayed and recorded process variable value will be inaccurate. In contrast, when using the models 126 and the one or more smart sensor devices, such as, for example, the sensor device 110 and/or the sensor device 310, the control system 120 can be a single source of configuration data. As such, there is no need for the control system 120 to match any field configuration of the sensor device 110 and/or the sensor device 310. Also, because the transmitter is eliminated from the sensor device 110 (e.g., because it uses Ethernet-APL to send the raw sensor data packet 200), security enhancements can be provided by reducing possible vulnerabilities that can be exploited by malicious attackers in the system 100. Moreover, the use of redundant sensors can be reduced (e.g., the use of redundant sensors in the same physical device), because the use of the virtual sensors 123 can provide improved availability of the sensor device 110.

Moreover, in the case where the sensor device 110 needs to be replaced for whatever reason (e.g., failure, damage, defects, etc.), the design of the system 100 allows for more efficient replacement, even if the sensor device is a different type of sensor. For example, consider a temperature control loop that receives a temperature input from the sensor device 110, where the sensor 114 is implemented as a Type J thermocouple configured in the control system 120 for an engineering unit range of 400° F. to 700° F. If the sensor device 110 is damaged and replaced with a new smart sensor device with a PT100 Resistance Temperature Detector (RTD), the control system 120 can immediately identify that the new smart sensor device has a PT100 RTD (and/or account for this difference) based on the sensor identifier (e.g., the sensor identifier 220). Accordingly, the control system 120 can automatically adjust the excitation voltage provided to the new smart sensor (e.g., to accommodate the PT100 RTD excitation as opposed to the passive thermocouple). Also, the control system 120 could automatically interpret the raw PT100 RTD sensor data by applying it to a translation function (e.g., a scaling function) for the PT100 RTD sensor instead of a translation function for a Type J thermocouple. In this manner, the control system 120 could continue controlling over the same engineering unit range of 400° F. to 700° F. and operate properly without requiring manual user interaction to configure the new sensor upon replacement.

Additionally, the system 100 can be used for other functionality beyond monitoring and control of the given operation. For example, the system 100 can be used for location tracking, asset management, safety shower monitoring, environmental health and safety, smart metering, equipment health monitoring, and other functions. The control system 120 can have access to a variety of different information associated with an operation such as, for example, temperature, pressure, flow, pH, conductivity, gas detection, discrete, level, vibration, mass-flow, energy usage, valve position, and other measurements and final control elements. The system 100 can include smart, model-based devices (e.g., the control device 330) that include advanced diagnostic functionality that allows them to diagnose the health of the device and, in many cases, the health of the process to which the device is connected. The smart devices can include diagnostic that, for example, can detect plugged lines, burner flame instability, agitator loss, wet gas, orifice wear, leaks, cavitations, excessive vibration, and other potentially problematic circumstances. The statistical process monitoring functionality on the smart devices can communicate information about the process being monitored, information about the overall network (e.g., the overall operation), and when devices and/or equipment need maintenance.

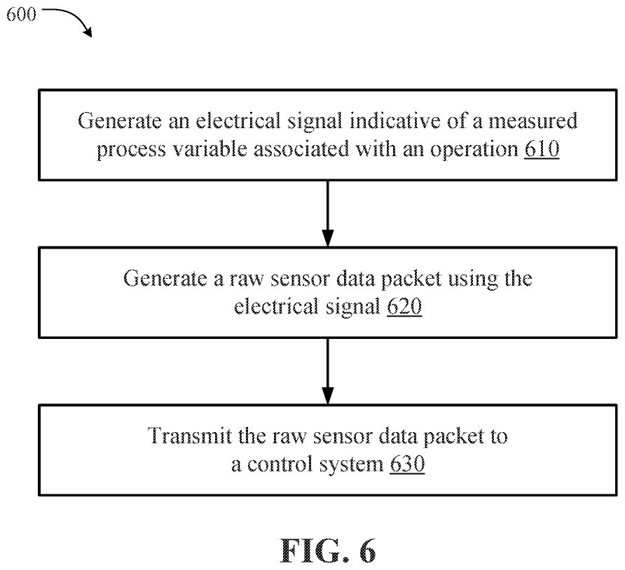

Referring to FIG. 6, a flowchart illustrating an example process 600 for generating and transmitting a raw sensor data input in the system 100 is shown, in accordance with some aspects of the disclosure. The process 600 can be performed by the sensor device 110, for example, and is described as such for illustration purposes. However, in some examples, the process 600 is executed by the sensor device 310 or another sensor device. The process 600 can provide a variety of advantages in terms of monitoring and controlling various types of operations, as detailed herein. For example, the process 600 can be used to provide improvements for automotive manufacturing operations, chemical processing operations, oil and gas operations, food and beverage manufacturing operations, medical manufacturing operations, paper manufacturing operations, water treatment operations, mining operations, packaging and filling operations, and other types of operations. Notably, in the process 600, the sensor device 110 produces a raw signal that is not manipulated locally on the sensor device, but rather is used and manipulated by the control system 120 (e.g., in the cloud).

At 610, the sensor device 110 can generate an electrical signal indicative of a measured process variable associated with an operation. For example, as noted, the sensor device 110 can include a sensor 114 that can be implemented using any suitable sensing elements, transducers, etc. that can measure a process variable. For example, the sensor 114 can be implemented using a thermocouple, a thermistor, a force-sensing resistor, a strain gauge, a piezoelectric element (e.g., a piezoelectric disc), a differential transformer, a capacitive pressure transducer, or any other suitable type of sensor and/or combination of sensors. The sensor 114 can measure any suitable type of process variable, such as, for example, a temperature process variable, a pressure process variable, a flow process variable, a level process variable, a concentration process variable, and/or any other suitable type of process variable associated with the operation. The sensor 114 can generate an electrical signal that is indicative of the measured process variable, such as, for example, an analog voltage signal or an analog current signal. The characteristics of the electrical signal generated by the sensor 114 can vary based on the type of sensor used.

At 620, the sensor device 110 can generate a raw sensor data packet using the electrical signal. In some examples, the generated raw sensor data packet is of the form of the raw sensor data packet 200 of FIG. 2 and described above. For example, the sensor device 110 can apply the electrical signal generated by the sensor 114 to the converter 112 to generate the raw value 210 included in the raw sensor data packet 200. As noted, the converter 112 can be implemented in a variety of ways, including as an analog-to-digital converter circuit (e.g., a delta-sigma analog-to-digital converter, a successive approximation analog-to-digital converter, a dual slope analog-to-digital converter, etc.) with various sampling rates and bit resolutions. Also, the sensor device 110 can include in the raw sensor data packet 200 both the sensor identifier 220 and the sensor operational data 230. The sensor identifier 220 can be a unique identifier of the sensor device 110 that is specific to particular type of sensor and/or the particular family of sensor (e.g., manufacturer X and type Y). The sensor operational data 230 can include any data that is indicative of an operational state of the sensor device 110 at a time when the converter 110 generates the raw sensor data packet 200.

At 630, the sensor device 110 can transmit the raw sensor data packet 200 to the control system 120. For example, the sensor device 110 can transmit the raw sensor data packet 200 to the control system 120 using an Ethernet-APL communications protocol. In some examples, the sensor device 110 transmits the raw sensor data packet 200 to the network device 320 using the Ethernet-APL communications protocol, and then the network device 320 transmits the raw sensor data packet 200 to the server 350 via the network 340. The use of Ethernet-APL specifically in the system 100 to transfer the raw sensor data packet 200 from the sensor device 110 to the control system 120 can provide a variety of advantages. For example, improvements in terms of enabling long cable lengths and safety protections can be achieved using Ethernet-APL. Additionally, the use of Ethernet-APL can remove the need for any wireless transmission components to be included in the sensor device 110, which can provide improved security for the sensor device 110 and the broader system 100 more generally.

In some examples, additional details of operation of the sensor device 110 (or 310) described above with respect to FIGS. 1-5 are similarly performed by the sensor device 110 in conjunction with performing the process 600. For example, as described above, the sensor device 110 may receive power from the control system 120 for powering the converter 112 and/or the sensor 114. Thus, although not restated here, such additional details of operation may be incorporated into the process 600, in some examples.

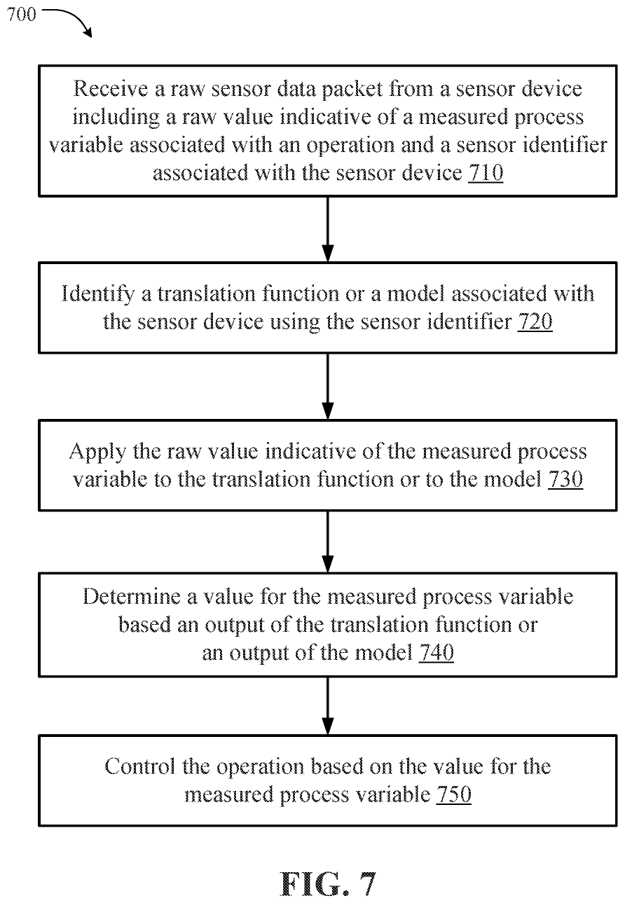

Referring to FIG. 7, a flowchart illustrating an example process 600 for controlling an operation using a raw sensor data input in the system 100 is shown, in accordance with some aspects of the disclosure. The process 700 can be performed by the control system 120, for example. The process 700 can provide a variety of advantages in terms of monitoring and controlling various types of operations, as detailed herein. For example, the process 700 can be used to provide improvements for automotive manufacturing operations, chemical processing operations, oil and gas operations, food and beverage manufacturing operations, medical manufacturing operations, paper manufacturing operations, water treatment operations, mining operations, packaging and filling operations, and other types of operations. Notably, in the process 700, the control system 120 receives a raw signal from the sensor device 110 that is not manipulated. Rather than the sensor device 110 manipulating the signal, the control system 120 performs signal manipulation functions on the raw data.

At 710, the control system 120 can receive a raw sensor data packet from the sensor device 110, where the raw sensor data packet includes the raw value and the sensor identifier. In some examples, the raw sensor data pack has the form of the raw sensor data packet 200 of FIG. 2 and described above. As noted, the raw sensor data packet 200 can further include the sensor operational data 230. The raw value 210 can be indicative of a measured process variable associated with an operation, such as, for example, a temperature process variable, a pressure process variable, a flow process variable, a level process variable, a concentration process variable, and/or any other suitable type of process variable associated with the operation. The sensor identifier 220 can be a unique identifier of the sensor device 110 that is specific to particular type of sensor and/or the particular family of sensor (e.g., manufacturer X and type Y). The sensor operational data 230 can include any data that is indicative of an operational state of the sensor device 110 at a time when the converter 110 generates the raw sensor data packet 200. In some examples, the control system 120 receives the raw sensor data packet from the sensor device 110 via a network connection. For example, as described above, the control system 120 may include the server 350. In such examples, at 710 in the process 700, the control system 120 receiving the raw sensor data packet from the sensor device 110 may include the server 350 receiving the raw sensor data packet 200 from the network device 320 via the network 340. In other examples, the control system 120 receives the raw sensor data packet from the sensor device 110 via another connection or path.

At 720, the control system 120 can identify one of the translation functions 124 or one of the models 126 associated with the sensor device 110 using the sensor identifier 220. For example, the control system 120 can use the sensor identifier 220 to identify one of the translation functions 124 or one of the models 126 associated with the sensor device 110 by looking up the sensor identifier 220 in the sensor library 122. The control system 120 can identify more than one of the translation functions 124 and/or more than one of the models 126 associated with the sensor device 110 using the sensor identifier 220 as well depending on the associations with the sensor identifier 220 in the sensor library 122. Moreover, the control system 120 can use the sensor identifier 220 to identify one or more of the corrective functions 125 associated with the sensor device 110. As noted, the use of the sensor library 122 to maintain the translation functions 124, the corrective functions 125, and the models 126 can provide advantages in terms of ease of configurability and updateability, among others.

At 730, the control system 120 can apply the raw value 210 indicative of the measure process variable to the identified one of the translation functions 124 or to the identified one of the models 126. The control system 120 can also apply the raw value 210 indicative of the measure process variable to an identified one of the corrective functions 125. In some examples, the raw value 210 can be a full resolution (e.g., 0-100%) digital version of the electrical signal generated by the sensor 114 to measure the process variable. The raw value 210 generally is not manipulated by the sensor device 110 itself, but rather by the control system 120 by means of the translation functions 124, the corrective functions 125, and/or the models 126. That is, the sensor device 110 does not perform any manipulation of the signal output by the converter 112, such as, for example, by performing amplification, linearization, converting and scaling, or other types of signal manipulation functions, but rather the control system 120 performs manipulation of the signal. In cases where the control system 120 applies the raw value 210 to the identified one of the models 126, the control system 120 can also provide additional data as input to the identified one of the models 126, such as, for example, a raw value from the sensor device 310 and/or values associated with one or more of the virtual sensors 123.

At 740, the control system 120 can determine a value for the measured process variable based on an output of the identified one of the translation functions 124 or based on an output of the identified one of the models 126. The control system 120 can further determine the value for the measured process variable based on the output of the identified one of the corrective functions 125. For example, the control system 120 can determine a final, accurate, usable value for the measured process variable based on the output of the identified one of the translation functions 124, the output of the identified one of the models 126, and/or the output of the identified one of the corrective functions 125. The output of the identified one of the translation functions 124 can be a translated value, the output of the identified one of the corrective functions 125 can be a corrective value, and the control system 120 can determine a final, accurate, usable value for the measured process variable by combining the translated value and the corrective value. The output of the identified one of the models 126 can account for multiple values for different process variables associated with the operation at a given time.

At 750, the control system 120 can control the operation based on the determined value for the measured process variable. For example, the control system 120 can send a control signal to the control device 330 based on the determined value for the measured process variable, and the control device 330 can use the control signal to control the operation. The control system 120 can send the control signal to the control device 330 via the network 340, for example. The control device 330 can use the control signal to affect the operation in various ways, such as, for example, changing valve position, control operation of machinery, and any other types of control functions that might be used affect the operation. Since the control system 120 accurately determines the value for the measured process variable using the translation functions 124, the corrective functions 125, and/or the models 126, the control system 120 can provide more efficient and effective control of the operation. Additionally, improvements in the overall performance of the system 100 can be improved in various ways as detailed throughout the disclosure.

In some examples, additional details of operation of the control device 120 described above with respect to FIGS. 1-5 are similarly performed by the control device 120 in conjunction with performing the process 700. For example, as described above, the control device 120 may provide power to the sensor device 110 for powering the converter 112 and/or the sensor 114. Thus, although not restated here, such additional details of operation may be incorporated into the process 700, in some examples.

This disclosure is not limited in its application to the details of construction and the arrangement of components set forth in this description or illustrated in the accompanying drawings. The disclosure is capable of other embodiments and of being practiced or of being carried out in various ways. Also, it is to be understood that the phraseology and terminology used herein is for the purpose of description and should not be regarded as limiting. The use of “including”, “comprising”, “containing”, or “having” and variations thereof herein is meant to encompass the items listed thereafter and equivalents thereof as well as additional items. Unless specified or limited otherwise, the terms “mounted”, “connected”, “supported”, “coupled”, and variations thereof are used broadly and encompass both direct and indirect mountings, connections, supports, and couplings. Further, “connected” and “coupled” are not restricted to physical or mechanical connections or couplings.

Some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media.

Some embodiments of the disclosure can include (or utilize) a control device such as, for example, an automation device, a computer including various computer hardware, software, firmware, and so on, consistent with the discussion below. As specific examples, a control device can include a processor, a microcontroller, a field-programmable gate array, a programmable logic controller, logic gates, etc., and other typical components that are known in the art for implementation of appropriate functionality (e.g., memory, communication systems, power sources, user interfaces and other inputs, etc.). Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

The term “article of manufacture” as used herein is intended to encompass a computer program accessible from any computer-readable device, carrier (e.g., non-transitory signals), or media (e.g., non-transitory media). For example, non-transitory computer-readable media can include but are not limited to magnetic storage devices (e.g., hard disk, floppy disk, magnetic strips, and so on), optical disks (e.g., compact disk (“CD”), digital versatile disk (“DVD”'), and so on), smart cards, and flash memory devices (e.g., card, stick, and so on). Additionally, it should be appreciated that a carrier wave can be employed to carry computer-readable electronic data such as, for example, those used in transmitting and receiving electronic mail or in accessing a network such as, for example, the Internet or a local area network (“LAN”). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as, for example, “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

As used herein, unless otherwise defined or limited, the phase “and/or” used with two or more items is intended to cover or include the items individually and the items together. For example, a device having “a and/or b” is intended to cover or include: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The provided detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

While the invention herein disclosed has been described in terms of specific embodiments and applications thereof, numerous modifications and variations could be made thereto by those skilled in the art without departing from the scope of the invention set forth in the claims.

1. A system for monitoring and controlling an operation, the system comprising:
a sensor device comprising a sensor configured to generate an electrical signal indicative of a measured process variable associated with the operation and a converter circuit configured to receive the electrical signal from the sensor and generate a raw sensor data packet using the electrical signal; and
a control system in electrical communication with the sensor device, the control system comprising one or more circuits configured to:
receive the raw sensor data packet from the sensor device;
calculate a value for the measured process variable based on the raw sensor data packet; and
control the operation based on the value for the measured process variable.

2. The system of claim 1, wherein the converter circuit of the sensor device is configured to generate the raw sensor data packet indicative of the measured process variable by converting the electrical signal to a digital signal without manipulating the digital signal.

3. The system of claim 1, wherein the raw sensor data packet comprises:
a raw value indicative of the measured process variable;
a sensor identifier associated with the sensor device; and
sensor operational data indicative of an operational state of the sensor device at a time when the converter circuit generates the raw sensor data packet.

4. The system of claim 3, wherein, to calculate the value for the measured process variable, the one or more circuits of the control system are configured to:
use the sensor identifier to identify a translation function and a corrective function associated with the sensor device that is maintained by the control system;
apply the raw value to the translation function to generate a translated value;
apply the sensor operational data to the corrective function to generate a corrective value; and
combine the translated value and the corrective value to generate the value for the measured process variable.

5. The system of claim 3, wherein, to calculate the value for the measured process variable, the one or more circuits of the control system are configured to:
use the sensor identifier to identify a model associated with the sensor device that is maintained by the control system;
apply the raw value to the model; and
generate the value for the measured process variable based on an output of the model.

6. The system of claim 5, wherein the output of the model accounts for a second value for a second measured process variable associated with the operation.

7. The system of claim 1, comprising a second sensor device comprising a second sensor configured to generate a second electrical signal indicative of a second measured process variable associated with the operation and a second converter circuit configured to receive the second electrical signal from the second sensor and generate a second raw sensor data packet, wherein the one or more circuits of the control system are configured to:
receive the second raw sensor data packet from the second sensor device;
calculate a second value for the second measured process variable based on the second raw sensor data packet;
generate a virtual sensor maintained by the control system, wherein a third value associated with the virtual sensor is indicative of a third measured process variable associated with the operation;
calculate the third value based on both the value for the measured process variable and the second value for the second measured process variable.

8. The system of claim 7, wherein the one or more circuits of the control system are configured to:
apply at least one of a mass balance or an energy balance to at least one of the value for the measured process variable or the second value for the second measured process variable to calculate the third value; and
identify a process issue associated with the operation based on the third value.

9. One or more non-transitory computer-readable storage media having instructions stored thereon that, when executed by one or more processors, cause the one or more processors to implement operations comprising:
receiving a raw sensor data packet from a sensor device, the raw sensor data packet comprising a raw value indicative of a measured process variable associated with an operation and a sensor identifier associated with the sensor device;
identifying a translation function associated with the sensor device that is maintained by a control system for the operation using the sensor identifier associated with the sensor device;
applying the raw value indicative of the measured process variable associated with the operation to the translation function to generate a translated value;
determining a value for the measured process variable associated with the operation based on the translated value; and
controlling the operation based on the value for the measured process variable.

10. The one or more non-transitory computer-readable storage media of claim 9, wherein receiving the raw value indicative of the measured process variable associated with the operation comprises receiving a raw digital value that has not been manipulated by the sensor device.

11. The one or more non-transitory computer-readable storage media of claim 9, wherein the raw sensor data packet comprises sensor operational data indicative of an operational state of the sensor device at a time when the sensor device generated the raw sensor data packet, the operations comprising:
identifying a corrective function associated with the sensor device that is maintained by the control system for the operation using the sensor identifier associated with the sensor device; and
applying the sensor operational data to the corrective function to generate a corrective value;
wherein determining the value for the measured process variable associated with the operation based on the translated value comprises determining the value for the measured process variable associated with the operation based on both the translated value and the corrective value.

12. The one or more non-transitory computer-readable storage media of claim 11, wherein the sensor operational data comprises temperature data indicative of an operational temperature associated with the sensor device at the at the time when the sensor device generated the raw sensor data packet.

13. The one or more non-transitory computer-readable storage media of claim 9, the operations comprising:
receiving a second raw sensor data packet from a second sensor device;
calculating a second value for a second measured process variable associated with the operation based on the second raw sensor data packet;
generating a virtual sensor, wherein a third value associated with the virtual sensor is indicative of a third measured process variable associated with the operation;
calculating the third value based on both the value for the measured process variable and the second value for the second measured process variable.

14. The one or more non-transitory computer-readable storage media of claim 13, the operations comprising:
calculating the third value by inferring the third value from the value for the measured process variable and the second value for the second measured process variable; and
validating at least one of the value for the measured process variable or the second value for the second measured process variable based on the third value.

15. A method for monitoring and controlling an operation, the method comprising:
receiving, by a control system, a raw sensor data packet from a sensor device, the raw sensor data packet comprising a raw value indicative of a measured process variable associated with an operation and a sensor identifier associated with the sensor device;
identifying, by the control system, a model associated with the sensor device that is maintained by a control system for the operation using the sensor identifier associated with the sensor device;
applying, by the control system, the raw value indicative of the measured process variable associated with the operation to the model;
determining, by the control system, a value for the measured process variable associated with the operation based on an output of the model; and
controlling, by the control system, the operation based on the value for the measured process variable.

16. The method of claim 15, wherein receiving the raw value indicative of the measured process variable associated with the operation comprises receiving a raw digital value that has not been manipulated by the sensor device.

17. The method of claim 15, wherein:
the raw sensor data packet comprises sensor operational data indicative of an operational state of the sensor device at a time when the sensor device generated the raw sensor data packet; and
applying the raw value indicative of the measured process variable associated with the operation to the model comprises applying both the raw value indicative of the measured process variable associated with the operation and the sensor operational data indicative of the operational state of the sensor device at the time when the sensor device generated the raw sensor data packet to the model.

18. The method of claim 17, wherein the sensor operational data comprises temperature data indicative of an operational temperature associated with the sensor device at the at the time when the sensor device generated the raw sensor data packet.

19. The method of claim 15, comprising:
receiving, by the control system, a second raw sensor data packet from a second sensor device;
calculating, by the control system, a second value for a second measured process variable associated with the operation based on the second raw sensor data packet;
generating, by the control system, a virtual sensor, wherein a third value associated with the virtual sensor is indicative of a third measured process variable associated with the operation;
calculating, by the control system, the third value based on both the value for the measured process variable and the second value for the second measured process variable.

20. The method of claim 15, comprising:
receiving, by the control system, a second raw sensor data packet from a second sensor device, the second raw sensor data packet comprising a second raw value indicative of a second measured process variable associated with the operation, wherein applying the raw value indicative of the measured process variable associated with the operation to the model comprises applying both the raw value indicative of the measured process variable associated with the operation and the second raw value indicative of a second measured process variable associated with the operation to the model; and
determining, by the control system, a second value for the second measured process variable associated with the operation based on the output of the model, wherein controlling the operation based on the value for the measured process variable comprises controlling the operation based on both the value for the measured process variable and the second value for the second measured process variable.
